(19) United States
(12) Patent Application Publication
(10) Pub. No.: US 2013/0028085 A1
(43) Pub. Date: Jan. 31, 2013

(54) FLOW CONTROL IN PACKET PROCESSING SYSTEMS

(71) Applicant: Guy Bilodeau, (US)

(72) Inventor: Guy Bilodeau, (US)

(21) Appl. No.: 13/192,618

(22) Filed: Jul. 28, 2011

(51) Int. Cl. H04L 12/26; H04L 12/56

(52) U.S. Cl. 370/235

(57) ABSTRACT

Flow control in a packet processing system includes obtaining metric data measuring utilization of at least one resource in the packet processing system over intervals of a time period. A value of a flow control load parameter is adjusted during each of the intervals based on comparing the metric data with at least one condition that indicates depletion of the at least one resource. A value of a packet flow budget is established for the packet processing system in each of the intervals based on the respective value of the flow control load parameter in each of the intervals.

### BACKGROUND

Computer networks include various devices that facilitate communication between computers using packetized formats and protocols, such as the ubiquitous Transmission Control Protocol/Internet Protocol (TCP/IP). Computer networks can include various packet processing systems for performing various types of packet processing, such as forwarding, switching, routing, analyzing, and like type packet operations. A packet processing system can have multiple network interfaces to different network devices for receiving packets. The multiple network interfaces are controlled by a common set of resources in the system (e.g., processor, memory, and like type resources).

Sometimes, a network interface can receive packets at too high of a rate (e.g., higher than a designated maximum rate for the network interface). Such a packet overflow condition can be intentional, such as an attacker sending many packets to a network interface in a Denial-of-Service (DoS) attack. Such a packet overflow condition can also be unintentional, such as too many devices trying to communicate through the same network interface, or incorrectly configured network device(s) sending too many packets to the network interface. In any case, a network interface receiving an overflow of packets can monopolize the resources of the packet processing system or otherwise cause the resources to become overloaded. Other network interface and/or other processes not associated with the overflowing network interface can become starved of resources in the packet processing system, causing such network interfaces and processes to stop working.

### BRIEF DESCRIPTION OF THE DRAWINGS

Some embodiments of the invention are described with respect to the following figures:

FIG. 1 is a block diagram of a packet processing system according to an example implementation;

FIG. 2 is a flow diagram depicting a method of flow control in a packet processing system according to an example implementation;

FIG. 3 is a flow diagram depicting a method of adjusting a flow control load parameter according to an example implementation;

FIG. 4 is a flow diagram depicting a method of adjusting a packet flow budget according to an example implementation; and

FIG. 5 is a block diagram of a computer according to an example implementation.

### DETAILED DESCRIPTION

Flow control in packet processing systems is described. In an embodiment, flow control in a packet processing system is implemented by first obtaining metric data measuring performance of at least one resource in the packet processing system over intervals of a time period. A value of a flow control load parameter is adjusted during each of the intervals based on comparing the metric data with at least one condition that indicates depletion of the resource(s). A value of a packet flow budget for the packet processing system is established in each of the intervals based on the respective value of the flow control load parameter in each of the intervals. Thus, after some time intervals have elapsed, where the usage of resource(s) is deemed to be too high, the packet flow budget can restrict the rate of packet processing in the packet processing system to conserve the resource(s). After other time intervals have elapsed, where usage of resource(s) is deemed to be normal, the packet flow budget can provide a standard rate of packet processing. The packet flow budget can be adjusted continuously over the time period based on feedback from measurements of resource performance.

The flow control process can be used to monitor the fraction of resource usage devoted to packet processing and continuously maintain packet flows through the system at a maximum rate that can be sustained by the packet processing system. In this manner, packet processing performance in the system is maximized, without starving other processes of resources. The flow control process does not rely on instructing the packet sources to stop sending packets in case of packet saturation, such as by multicasting an Ethernet PAUSE frame. Such an instruction will cause all packet sources to stop transmitting, even those that are not excessively transmitting packets and causing the problem. Further, some packet sources may ignore such an instruction, particularly if the packet sources are maliciously transmitting excessive packets. Finally, the exact duration of such pause instruction is difficult to calculate, which can cause a larger than necessary delay before the instruction is sent, received, and acted upon, leading to too much flow restriction and wasted bandwidth utilization. Rather than focusing on the packet sources, the flow control process described herein uses metrics internal to the packet processing system to make decisions on if and by how much the packet flow should be restricted. Various embodiments are described below by referring to several examples.

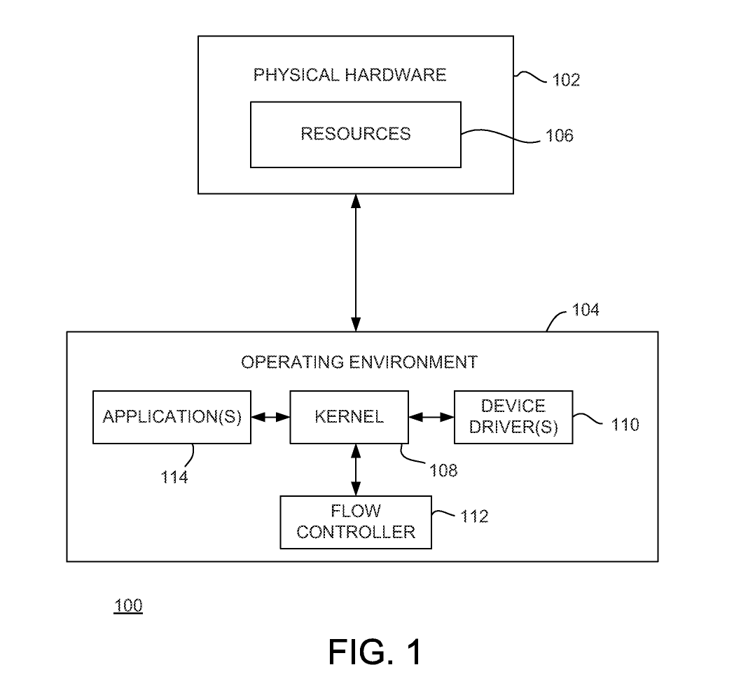

FIG. 1 is a block diagram of a packet processing system 100 according to an example implementation. The packet processing system 100 includes physical hardware 102 that implements an operating environment (OE) 104. The physical hardware 102 includes resources 106 managed by the OE 104. The packet processing system 100 can be implemented as any type of computer, device, appliance or the like. The resources 106 can include processor(s), memory (e.g., volatile memories, non-volatile memories, magnetic and/or optical storage, etc.), interface circuits to external devices, and the like. In particular, the packet processing system 100 can use the resource(s) to send and receive packetized data (“packets”). The packets can be formatted using multiple layers of protocol, e.g., the Transmission Control Protocol (TCP) Internet Protocol (IP) (“TCP/IP”) model, Open Systems Interconnection (OSI) model, or the like. A packet generally includes a header and a payload. The header implements a layer of protocol, and the payload includes data, which may be related to packet(s) at another layer of protocol.

The resources 106 can operate on a flow of the packet (“packet flow”). As used herein, a “packet flow” is a sequence of packets passing an observation point, such as any of the resources 106. A “packet rate” for a packet flow is the number of packets in the sequence passing the observation point over a time interval. The more packets in the sequence, the higher the packet rate. Conversely, the fewer packets in the sequence, the lower the packet rate. The packet flow can originate from at least one source.

In an example, the physical hardware 102 can execute machine-readable instructions to implement elements of functionality in the OE 104 (e.g., using at least one of the resources 106, such as a processor). In another example, elements of functionality in the OE 104 can be implemented as a physical circuit in the physical hardware 102 (e.g., an integrated circuit (IC), such as an application specific integrated circuit (ASIC) or field programmable gate array (FPGA)). In yet another example, elements of functionality in the OE 104 are implemented using a combination of machine-readable instructions and physical circuits.

Elements of functionality in the OE 104 include a kernel 108, at least one device driver (“device driver(s) 110”), a packet flow controller 112, and at least one application (“application(s) 114”). The kernel 108 controls the execution of the application(s) 114 and access to the resources 106 by the application(s) 114. The kernel 108 provides an application interface to the resources 106. The device driver(s) 110 provide an interface between the kernel 108 and at least a portion of the resources 106 (e.g., a network interface resource). The device driver(s) 110 provide a kernel interface to the resources 106. The application(s) 114 can include at least one distinct process implemented by the physical hardware 102 under direction of the kernel 108 (e.g., using at least one of the resources 106, such as a processor). The application(s) 114 can include process(es) that generate and consume packets to be sent or received by the packet processing system 100.

The packet flow controller 112 cooperates with the kernel 108 to monitor and control the packet flow received by the packet processing system 100. The packet flow controller 112 monitors the impact the packet flow has on the resources 106 of the packet processing system 100 in terms of resource utilization. When resource utilization exceeds a designated threshold, the packet flow controller 112 can implement flow control to restrict the packet rate of the packet flow.

In an example, the packet flow controller 112 obtains metric data from the kernel 108 over intervals of a time period. The metric data measures utilization of at least a portion of the resources 106 with respect to processing the packet flow. For example, the packet flow controller 112 can obtain metric data from the kernel every 30 seconds, every minute, every five minutes, or any other time interval. In an example, the resources monitored by the packet flow controller 112 can include processor(s), memory, and/or network interfaces. The metric data includes a measure of utilization for each of the monitored resources associated over each of the time intervals attributed to processing the packet flow.

The utilization measure can be expressed differently, depending on the type of resource being monitored and the type of information provided by the kernel 108. For example, processor utilization can be measured in terms of the fraction of time during a respective interval that the processor processes the packet flow. Memory utilization can be measured in terms of the amount of free memory or the amount of used memory. Network interface utilization can be measured in terms of the number of packets dropped internally during the time interval. It is to be understood that other measures of utilization can be used which, in general, include a range of possible values.

The packet flow controller 112 establishes a flow control load parameter. The packet flow controller 112 adjusts the value of the flow control load parameter after each of the time intervals based on the metric data. In an example, for each time interval, the packet flow controller 112 compares the metric data to at least one condition that indicates depletion of the monitored resources (“depletion condition”). For example, a depletion condition for processor utilization can be some threshold percentage of processing time devoted to processing the packet flow (e.g., if the processor is spending 98% of its time processing packets, processor utilization is deemed depleted). A depletion condition for memory utilization can be some threshold amount of free memory (e.g., if free memory drops below the threshold, then the memory is deemed depleted). A depletion condition for network interface utilization can be some threshold number of packets being dropped by the interface (e.g., if the interface drops more than the threshold number of packets, then the network interface is deemed depleted). These depletion conditions are merely examples, as other types of conditions can be formed based on the particular types of utilization measures in the metric data.

In an example, the flow control load parameter is an integer between minimum and maximum values (e.g., an integer between 0 and 255). The flow control load parameter indicates how much relative flow control must be applied to the packet processing system 100, where a minimum value indicates no flow control and a maximum value indicates maximum flow control. During each time interval, the packet flow controller 112 can increment or decrement the flow control load parameter. Whether the flow control load parameter is incremented or decremented depends on the relation between the metric data and the depletion condition(s). The metric data can be compared against any single depletion condition or any logical combination of multiple depletion conditions. For example, the flow control load parameter can be incremented if the processor utilization exceeds a threshold percentage or if the amount of free memory drops below a threshold or if the amount of dropped packets by a network interface exceeds a threshold. Conversely, the flow control load parameter can be decremented if the processor utilization is below the threshold and the amount of free memory is above the threshold and if the amount of dropped packets is below the threshold. The above logical combination of depletion conditions is an example and other combinations can be used to determine if more or less flow control is required by incrementing or decrementing the flow control load parameter. The size of the increment/decrement can be any number relative to the range between minimum and maximum values (e.g., ±1 with a range between 0 and 255).

The packet flow controller 112 can use the flow control load parameter to implement selective flow control. The packet flow controller 112 can determine a packet flow budget based on the flow control load parameter. In an example, when the kernel 108 is ready to handle more packets, the kernel 108 instructs the device driver(s) 110 for network interface(s) in the resources 106 to allow a certain amount of packets in the packet flow (the “packet flow budget”). Initially, the packet flow budget is set to a standard value, which allows the device driver(s) 110 to accept as many packets as designed. When the flow control load parameter is at the minimum value, the packet flow controller 112 does not provide flow control and does not adjust the packet flow budget from its standard value. When the flow control load parameter rises above the minimum value, the packet flow controller 112 adjusts the packet flow budget to implement flow control. The packet flow budget can be adjusted based on a function of the value of the flow control load parameter. For example, the packet flow controller 112 can adjust the packet flow budget to a calculated value inversely proportional to the value of the flow control load parameter. When the packet flow budget is reduced from the standard value, the device driver(s) 110 can drop packets from the packet flow so that the packet rate complies with the packet flow budget. The packets are dropped by the action of the packet flow controller 112 without requiring any explicit handling by any processor in the resources 106.

As the flow control load parameter increases over time, the packet flow budget is decreased. Stated differently, as the resources 106 in the packet processing system 100 become more depleted over time, fewer packets are allowed into the system 100 for processing. As the depletion condition is mitigated or removed over time, more packets are allowed into the system 100 for processing. The net effect is that the packet rate of the packet flow is continuously adjusted (potentially after every time interval) to mitigate or avoid depletion of the resources 106. By continuously estimating resource utilization required by the packet flow and applying a variable amount of negative feedback to the packet flow budget, the packet flow controller 112 guards against any voluntary or accidental surge in packet flow, such as in a Denial of Service type attack. The packet flow controller 112 also keeps the packet processing system 100 operating at an optimal point, where a maximum amount of packets are processed while leaving some amount of the resources 106 available for other use.

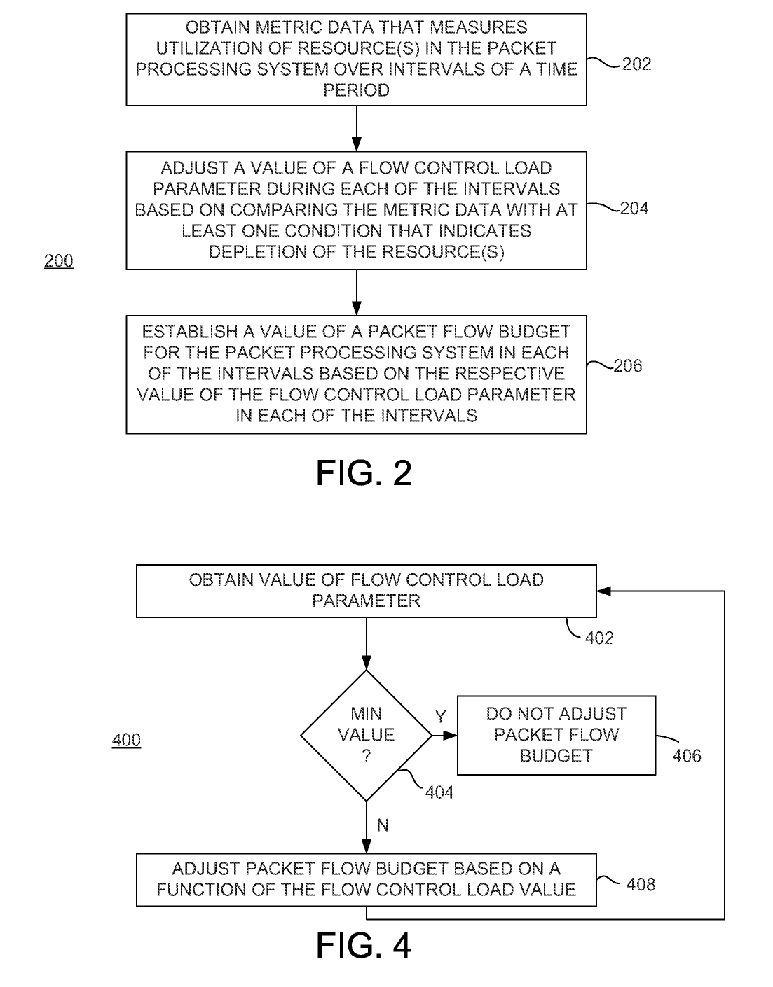

FIG. 2 is a flow diagram depicting a method 200 of flow control in a packet processing system according to an example implementation. The method 200 can be performed by the packet processing system 100 described above. The method 200 begins at step 202, where metric data is obtained that measures utilization of resource(s) in the packet processing system over intervals of a time period. At step 204, a value of a flow control load parameter is adjusted during each of the intervals based on comparing the metric data with at least one condition that indicates depletion of the resource(s). At step 206, a value of a packet flow budget for the packet processing system is established in each of the intervals based on the respective value of the flow control load parameter in each of the intervals.

In an example, the metric data can include data for central processing unit (CPU) use, memory use, and/or network interface use. In an example, the data for the CPU use can include a fraction of time during a respective interval that at least one CPU in the packet processing system processes packets. In an example, the flow control load parameter is an integer between minimum and maximum values. The value of the flow control load parameter can be adjusted by incrementing or decrementing the flow control load parameter in each of the intervals.

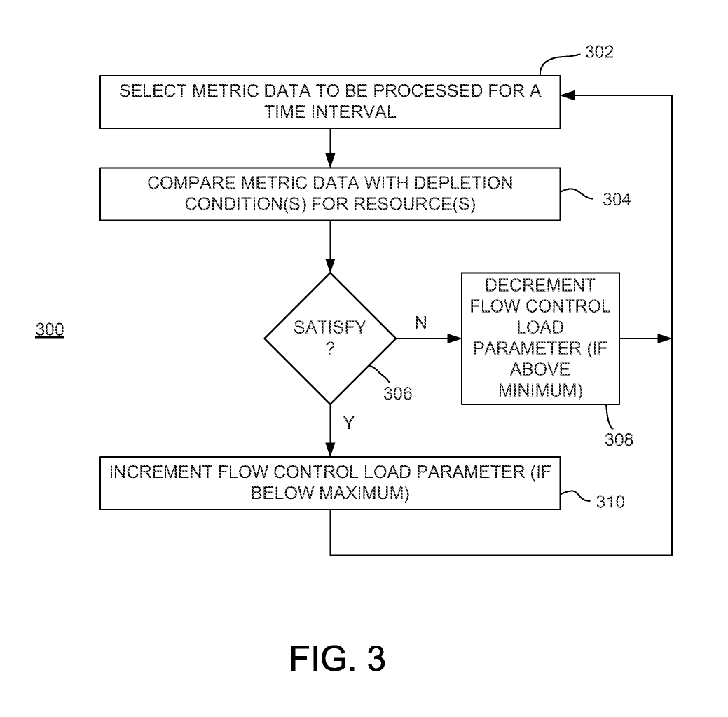

FIG. 3 is a flow diagram depicting a method 300 of adjusting a flow control load parameter according to an example implementation. The method 300 can be performed during step 204 of the method 200 shown in FIG. 2. The method 300 begins at step 302, where metric data is selected to be processed for a time interval. At step 304, the metric data is compared with depletion condition(s) for resource(s) in the packet processing system. As described above, the depletion conditions can be formed into various logical combinations. At step 306, a determination is made whether the metric data satisfies the depletion condition(s). If not, the method 300 proceeds to step 308. At step 308, the flow control load parameter is decremented if the flow control load parameter is greater than the minimum value. The method 300 proceeds from step 308 to step 302 for another time interval. If the metric data satisfies the depletion condition(s) at step 306, the method 300 proceeds to step 310. At step 310, the flow control load parameter is incremented if the flow control load parameter is less than the maximum value. The method 300 proceeds from step 310 to step 302 for another time interval.

Returning to FIG. 2, in an example, the flow control load parameter is an integer having a minimum value (e.g., zero). The packet flow budget is set to a standard value if the flow control load parameter is the minimum value (e.g., zero). If the flow control load parameter is greater than the minimum value, the packet flow budget is set to a calculated value that is a function of the flow control load parameter. In an example, the packet flow budget is adjusted inversely proportional to the respective value of the flow control load parameter.

FIG. 4 is a flow diagram depicting a method 400 of adjusting a packet flow budget according to an example implementation. The method 400 can be performed as part of the step 206 of the method 200 shown in FIG. 2. The method 400 begins at step 402, where a value of the flow control load parameter is obtained. The value of the flow control load parameter can range from minimum to maximum values. At step 404, a determination is made whether the flow control load parameter is a minimum value. If so, the method 400 proceeds to step 406. At step 406, the packet flow budget for the packet processing system is not adjusted. That is, flow control is not applied to the packet flow. The method 400 returns to step 402. If at step 404 the flow control load parameter is not the minimum value, the method 400 proceeds to step 408. At step 408, the packet flow budget for the packet processing system is adjusted based on a function of the flow control load value. The method 400 returns to step 402.

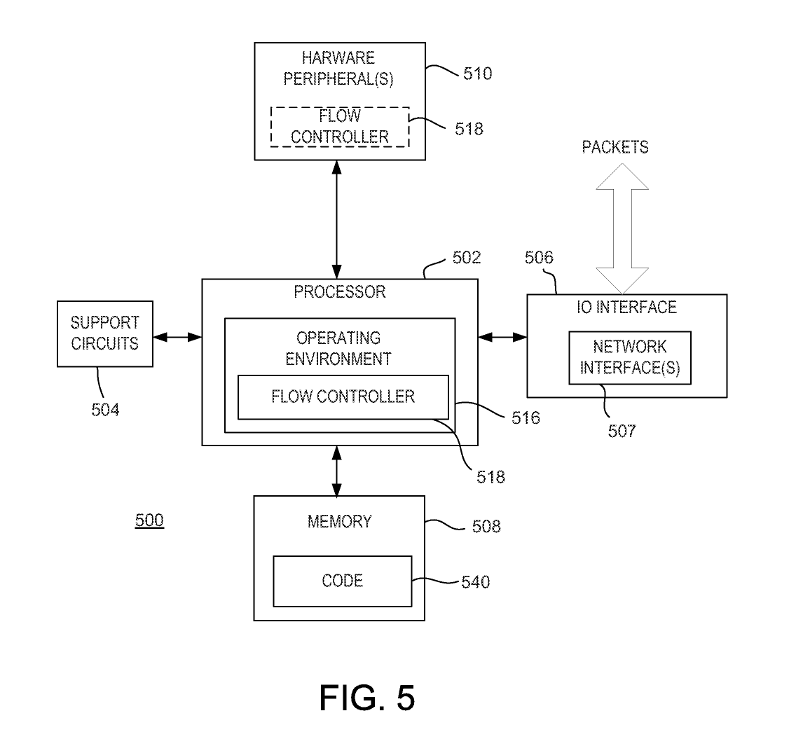

FIG. 5 is a block diagram of a computer 500 according to an example implementation. The computer 500 includes a processor 502, support circuits 504, an IO interface 506, a memory 508, and hardware peripheral(s) 510. The processor 502 includes any type of microprocessor, microcontroller, microcomputer, or like type computing device known in the art. The processor 502 can include one or more of such processing devices, and each of the processing devices can include one or more processing “cores”. The support circuits 504 for the processor 502 can include cache, power supplies, clock circuits, data registers, IO circuits, and the like. The IO interface 506 can be directly coupled to the memory 508, or coupled to the memory 508 through the processor 502. The IO interface 506 can include at least one network interface (“network interface(s) 507”).

The memory 508 can include random access memory, read only memory, cache memory, magnetic read/write memory, or the like or any combination of such memory devices. The hardware peripheral(s) 510 can include various hardware circuits that perform functions on behalf of the processor 502 and the computer 500. The memory 508 can store machine readable code 540 that is executed or interpreted by the processor 502 to implement an operating environment 516. The operating environment 516 includes a packet flow controller 518. In another example, the packet flow controller can be implemented as a dedicated circuit on the hardware peripheral(s) 510. For example, the hardware peripheral(s) 510 can include a programmable logic device (PLD), such as a field programmable gate array (FPGA), which can be programmed to implement the function of the packet flow controller 518.

In an example, the network interface(s) 507 can receive packets from packet source(s), which can be external to the computer 500. The packets received by the network interface(s) 507 form a packet flow for the computer 500 that is processed in the operating environment 516. The packet flow controller 518 selectively implements flow control on the packet flow. In an example, the packet flow controller 518 obtains metric data measuring utilization of at least one of the network interface(s) 507, the memory 508, or the processor 502 in each of a plurality of time intervals. The packet flow controller 518 compares the metric data to at least one condition in each of the plurality of time intervals to maintain a flow control load parameter. The packet flow controller 518 establishes a packet flow budget for the network interface(s) 507 in each of the plurality of time intervals based on respective values of the flow control load parameter in each of the plurality of time intervals.

In an example, the at least one condition against which the metric data is compared indicates depletion of at least one of the network interface(s) 507, the memory 508, and the processor 502. In an example, the flow control load parameter is an integer between minimum and maximum values, and packet flow controller 518 increments or decrements the flow control load parameter in each of the plurality of time intervals. In an example, the flow control load parameter is an integer, and the packet flow controller 518 reduces the packet flow budget based on a function of the flow control load parameter if the respective value of the flow control load parameter is not a minimum value. Otherwise, the packet flow controller 518 maintains the packet flow budget at a standard value if the respective value of the flow control load parameter is the minimum value. In an example, the minimum value is zero and the if the respective value of the flow control load parameter is not zero, the packet flow controller 518 sets the packet flow budget to a calculated value inversely proportional to the respective value of the flow control load parameter.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc., just to name a few. Other new and various types of computer-readable media may be used to store machine readable code discussed herein.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of flow control in a packet processing system, comprising:
obtaining metric data measuring utilization of at least one resource in the packet processing system over intervals of a time period;
adjusting a value of a flow control load parameter during each of the intervals based on comparing the metric data with at least one condition that indicates depletion of the at least one resource; and
establishing a value of a packet flow budget for the packet processing system in each of the intervals based on the respective value of the flow control load parameter in each of the intervals.

2. The method of claim 1, wherein the metric data includes data for at least one of central processing unit (CPU) use, memory use, or network interface use.

3. The method of claim 2, wherein the data for the CPU use includes a fraction of time during a respective interval of the intervals in which at least one CPU processes packets.

4. The method of claim 1, wherein the flow control load parameter is an integer between minimum and maximum values, and wherein the step of adjusting includes incrementing or decrementing the flow control load parameter in each of the intervals.

5. The method of claim 4, wherein the step of incrementing or decrementing in each of the intervals includes decrementing the flow control load parameter if during a respective interval of the intervals the metric data satisfies each of the at least one condition, or otherwise incrementing the flow control load parameter.

6. The method of claim 1, wherein the flow control load parameter is an integer, and wherein the step of establishing includes reducing the packet flow budget based on a function of the flow control load parameter if the respective value of the flow control load parameter is not a minimum value, or otherwise maintaining the packet flow budget at a standard value if the respective value of the flow control load parameter is the minimum value.

7. The method of claim 6, wherein the minimum value is zero and if the respective value of the flow control load parameter is not zero, setting the packet flow budget to a calculated value inversely proportional to the respective value of the flow control load parameter.

8. An apparatus to provide flow control in a packet processing system, comprising:
a network interface to receive packets;
a memory; and
a processor, communicatively coupled to the network interface and the memory, to obtain metric data measuring utilization of at least one of the network interface, the memory, or the processor in each of a plurality of time intervals, compare the metric data to at least one condition in each of the plurality of time intervals to maintain a flow control load parameter, and establish a packet flow budget for the network interface in each of the plurality of time intervals based on respective values of the flow control load parameter in each of the plurality of time intervals.

9. The apparatus of claim 8, wherein the at least one condition indicates depletion of at least one of the network interface, the memory, or the processor.

10. The apparatus of claim 8, wherein the flow control load parameter is an integer between minimum and maximum values, and wherein the processor increments or decrements the flow control load parameter in each of the plurality of time intervals.

11. The apparatus of claim 8, wherein the flow control load parameter is an integer, and wherein the processor reduces the packet flow budget based on a function of the flow control load parameter if the respective value of the flow control load parameter is not a minimum value, or otherwise maintains the packet flow budget at a standard value if the respective value of the flow control load parameter is the minimum value.

12. The apparatus of claim 11, wherein the minimum value is zero and if the respective value of the flow control load parameter is not zero, the processor sets the packet flow budget to a calculated value inversely proportional to the respective value of the flow control load parameter.

13. A packet processing system, comprising:
physical hardware including resources to process a packet flow; and
an operating environment including:
a kernel to provide an application interface to the resources;
device drivers to provide a kernel interface to the resources; and
a packet flow controller to obtain metric data from the kernel that measures utilization of the resources over intervals of a time period, adjusts a value of the flow control load parameter during each of the intervals based on the metric data, and establishes a value of a packet flow budget for the packet flow in each of the intervals based on the respective value of the flow control load parameter in each of the intervals.

14. The packet processing system of claim 13, wherein the resources include at least one of a processor, a network interface, or a memory.

15. The packet processing system of claim 13, wherein the packet flow controller adjusts the value of the flow control load parameter during each of the intervals by comparing the metric data to at least one condition that indicates depletion of at least one of the resources.

16. The packet processing system of claim 13, wherein the flow control load parameter is an integer between minimum and maximum values, and wherein the packet flow controller increments or decrements the flow control load parameter in each of the time intervals.

17. The packet processing system of claim 13, wherein the flow control load parameter is an integer, and wherein the packet flow controller reduces the packet flow budget based on a function of the flow control load parameter if the respective value of the flow control load parameter is not a minimum value, or otherwise maintains the packet flow budget at a standard value if the respective value of the flow control load parameter is the minimum value.

18. The packet processing system of claim 7, wherein the minimum value is zero and if the respective value of the flow control load parameter is not zero, the packet flow controller sets the packet flow budget to a calculated value inversely proportional to the respective value of the flow control load parameter.
